(19) United States
(12) Patent Application Publication
(10) Pub. No.: US 2026/0097875 A1
(43) Pub. Date: Apr. 9, 2026

(54) Connecting device

(71) Applicant: HECHT Technologie GmbH, Pfaffenhofen/Ilm (DE)

(72) Inventors: Josef HEINZINGER, Pfaffenhofen/Ilm (DE); Florian PILSNER, Pfaffenhofen/Ilm (DE)

(21) Appl. No.: 19/349,175

(22) Filed: Oct. 3, 2025

(30) Foreign Application Priority Data
Oct. 4, 2024 (DE) 10 2024 128 762.4
Dec. 24, 2024 (DE) 10 2024 139 741.1

(51) Int. Cl. B65B 39/08; B65B 1/04

(52) U.S. Cl. CPC B65B 39/08; B65B 1/04

(57) ABSTRACT

The application relates to a connecting device for connecting a tubular film to a device to transfer a product, in particular in powder/granular form, through the tubular film into and/or out of the device, the connecting device including: a base body forming a channel through which the product flows during transfer, wherein the channel extends along a channel axis and ends at an opening of the base body and opens to the outside; an adjustable sealing device being adjustable between (i) a connecting position in which it is spaced from the base body and allows the tubular film to be drawn over the base body, and (ii) a sealing position in which it seals the tubular film drawn over the base body with respect to the base body for transferring the product; and a clamping device which runs around the base body and is configured to clamp the tubular film drawn over the base body in a sealed manner in a clamping region by pressing the tubular film flat against the base body in the clamping region without changing its course; wherein the adjustable sealing device can be moved into an intermediate position located between the connecting position and the sealing position, in which it presses the tubular film drawn over the base body without changing its course onto a film remnant clamped in the clamping device, which originates from a previous transfer, in such a way that the film remnant rests against the base body and can preferably be pulled manually into the channel after the clamping device has been released.

The invention relates to a connecting device for connecting a tubular film to a device to transfer a product, in particular in powder/granular form, through the tubular film into and/or out of the device.

A device for transferring process material between a first container and a second container is known from document WO 2015/027350 A1.

The device comprises a first tensioner in which a film remnant from a container that has already been emptied is clamped. When a new container is connected, the film remnant is pulled out manually through a lateral access before a new liner film of a new container clamped in a second tensioner is crimped axially into the first tensioner.

Manually pulling out the crimped film remnant through the lateral access requires a great deal of force and is therefore difficult for the user.

This is due to the fact that the crimped course of the film remnant represents a mechanical resistance and pulling it out requires a lot of force. This problem is exacerbated in particular if the film remnant is coated, for example aluminum-laminated, and has increased inherent rigidity.

Against this background, it is an object of the invention is to create a more user-friendly connecting device. At least it is an object of the invention to obtain an alternative solution to the prior art.

This object(s) is solved by a connecting device according to claim 1. Preferred embodiments are subject-matters of the dependent claims.

The connecting device according to the invention for connecting a tubular film to a device to transfer a product, in particular in powder/granular form, through the tubular film into and/or out of the device, comprises in particular:
a base body forming a channel through which the product flows during transfer, wherein the channel extends along a channel axis and ends at an opening of the base body and opens to the outside;
an adjustable sealing device being adjustable between (i) a connecting position in which it is spaced from the base body and allows the tubular film to be drawn over the base body, and (ii) a sealing position in which it seals the tubular film drawn over the base body with respect to the base body for transferring the product; and
a clamping device which runs around the base body and is configured to clamp the tubular film drawn over the base body in a sealed manner in a clamping region by pressing the tubular film flat against the base body in the clamping region without changing its course; wherein
the adjustable sealing device can be moved into an intermediate position located between the connecting position and the sealing position, in which it presses the tubular film drawn over the base body without changing its course onto a film remnant clamped in the clamping device, which originates from a previous transfer, in such a way that the film remnant rests against the base body and can preferably be pulled manually into the channel after the clamping device has been released.

The clamping device is configured to clamp the tubular film without changing its course. This means that the film is clamped without folding and/or constricting.

In particular, the film is clamped in such a way that the film retains its straight course when clamped. This means that no clamping devices acting axially in with respect to the channel axis, into which the film is constricted for clamping, or clamping devices acting radially with respect to the channel axis, into which the film is crimped, are provided.

This makes it much easier for the user to pull the film remnant into the channel, as no radial constrictions or axial folds, which create mechanical resistance, need to be released manually.

The film remnant is pulled into the channel, for example, via a lateral access.

The film pulled over the base body is pressed against the film remnant in particular to such an extent that the film remnant rests against the base body in such a way that the film remnant is pulled/removed without contamination.

The pressure of the film pulled over the base body against the film remnant is also so strong that after removing the film remnant, the film pulled over the base body is pressed directly against the base body.

For example, the tubular film is part of a container in which the powder/granular product is contained and which is emptied into the device.

Alternatively, the tubular film can be part of a container into which the powdered/granular product from the device is filled.

In both cases, the tubular film can either be an integral part of the container or, alternatively, a tubular piece of film that is attached to the container on the one hand and to the device on the other.

The tubular film is a particularly preferred integral part of a big bag and forms the inlet and/or outlet of the big bag.

Preferably, the connecting device is constructed such that
the tubular film is fixed exclusively by the sealing device when the sealing device is in the intermediate position and presses the tubular film onto the film remnant, and
the tubular film is clamped in the clamping region by the clamping device as intended after the film remnant has been pulled into the channel.

After removal of the film remnant, the film pulled over the base body is clamped in the clamping region by the clamping device without any change in direction, wherein this clamping can take place before or after the sealing device is adjusted so as to be in the sealing position.

The connecting device is preferably designed so that in the intermediate position, the sealing device presses the tubular film radially and/or axially to the channel axis onto the film remnant. For example, the sealing lip, which is explained below, can press the tubular film radially and/or axially to the channel axis onto the film remnant.

Preferably, the connecting device is constructed such that
the sealing device comprises (i) a sealing ring which, in the sealing position of the sealing device, seals the tubular film radially and/or axially relative to the channel axis with respect to the base body, and (ii) a strip ring held at a distance from the sealing ring, which strips the tubular film over the film remnant and presses it onto the film remnant when the sealing device is adjusted so as to be in the intermediate position.

In particular, the sealing device is configured such that the user guides the tubular film through the sealing ring and the strip ring before pulling the tubular film over the base body and the film remnant attached to it.

Preferably, the connecting device is constructed such that
when the sealing device is adjusted to be in the intermediate position, the strip ring strips the tubular film axially to the channel axis over the film remnant and presses radially to the channel axis onto the film remnant, and
the sealing ring seals the tubular film by adjusting the sealing device from the intermediate position to the sealing position axially to the channel axis opposite an end face of the opening.

For this purpose, the sealing ring preferably has a seal that faces the aforementioned end face of the opening in the base body.

Preferably, the connecting device is constructed such that the strip ring can be moved axially to the channel axis relative to the sealing ring and remains stationary when the sealing device is adjusted from the intermediate position to the sealing position.

Preferably, the connecting device is constructed such that the base body has an outer surface running exclusively parallel to the channel axis, at least from the clamping area to the opening, onto which the sealing device presses the film residue in the intermediate position indirectly over the tubular film and onto which the clamping device presses the tubular film in the clamping area without changing the course.

In particular, no recesses, such as slits or indentations, are formed on the outer surface and the end face of the opening in which the tubular film is clamped.

Preferably, the connecting device is constructed such that
the clamping device is a tensioning strap or a bag clamp that presses the tubular film flat against the base body.

The tensioning strap may be an elastic strap that can be opened and closed using a buckle.

The alternative bag clamp is preferably made up of a number of swivel arms. For example, the bag clamp has two or three swivel arms that are adapted to an outer contour of the base body and are connected to each other by means of joints. The bag clamp is preferably mounted in such a way that it can be opened and closed in a plane perpendicular to the channel axis.

Below, a preferred embodiment of the invention is explained with reference to the attached figures.

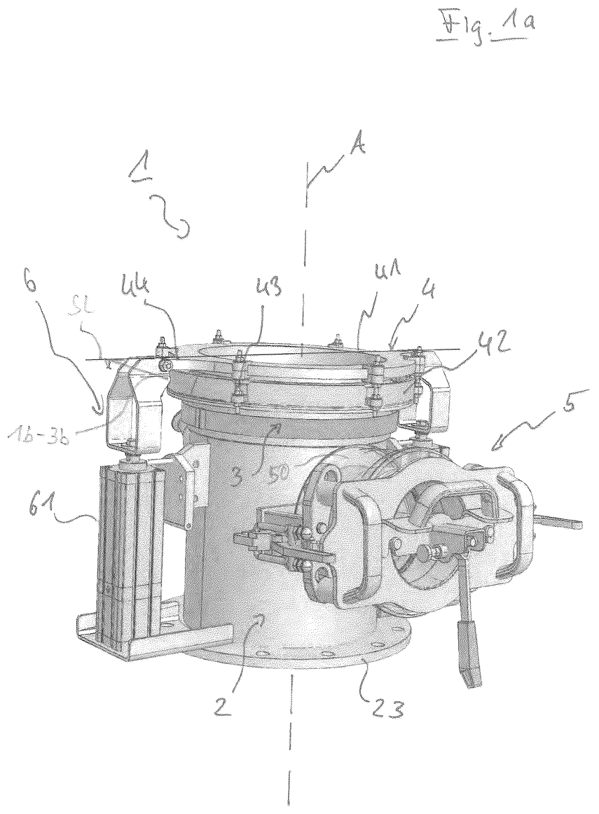

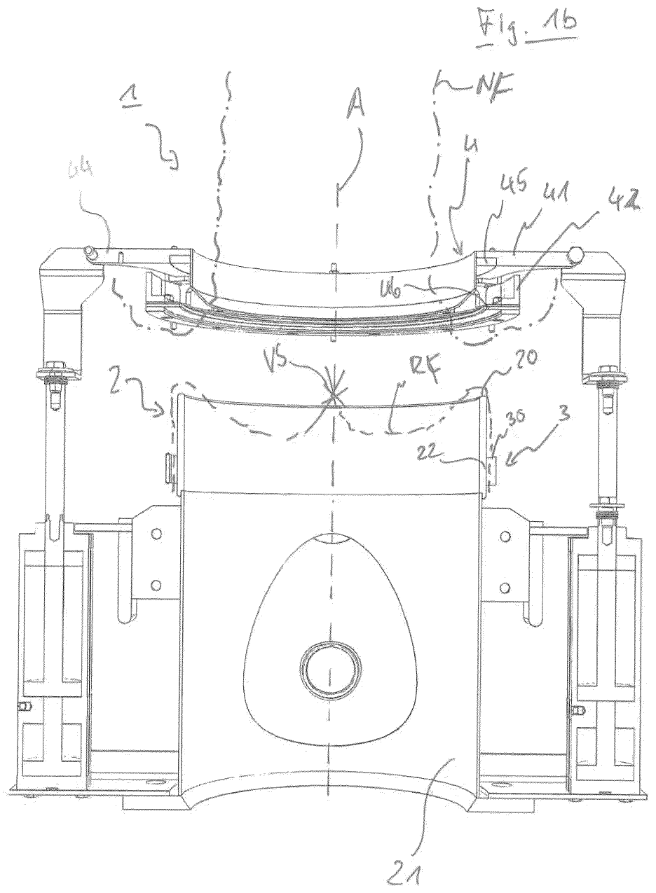

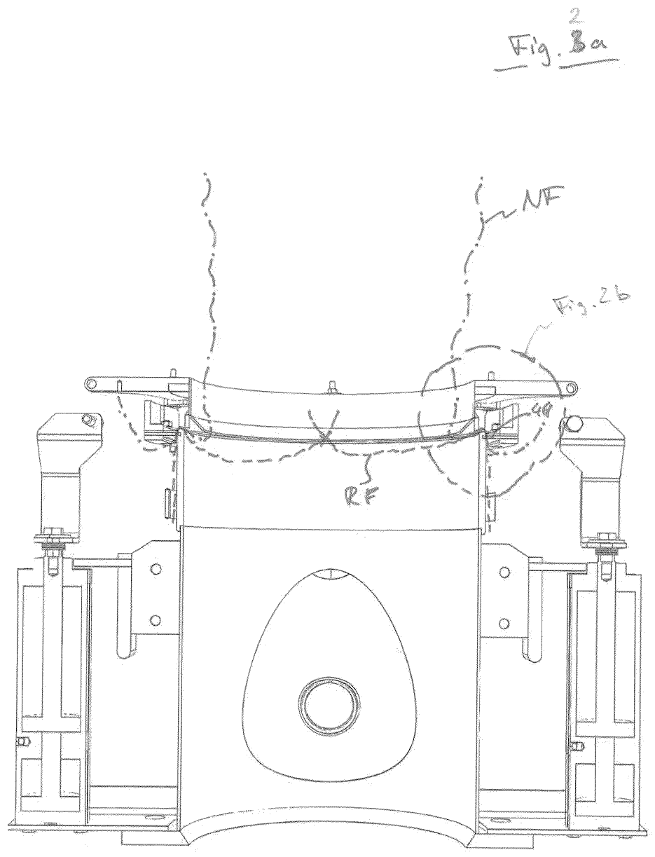

FIG. 1a shows a perspective view of a connecting device according to the invention, with a sealing device in a sealing position sealing a tubular film not shown.

FIG. 1b shows the connecting device according to the invention, with the sealing device in a connecting position allowing the connection of a new tubular film.

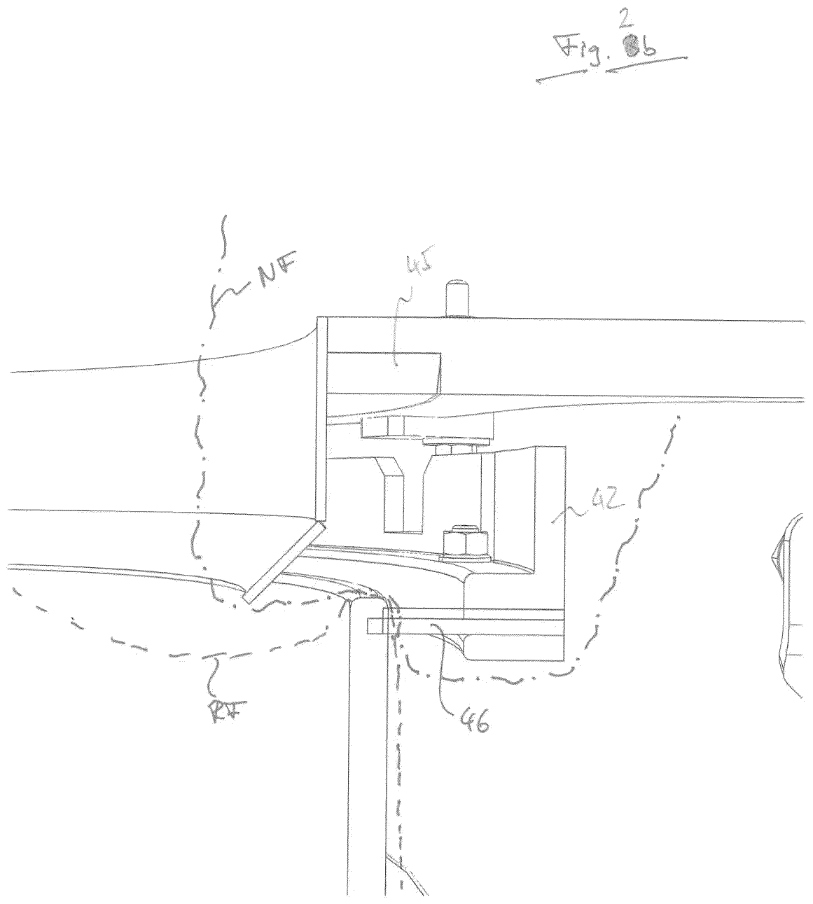

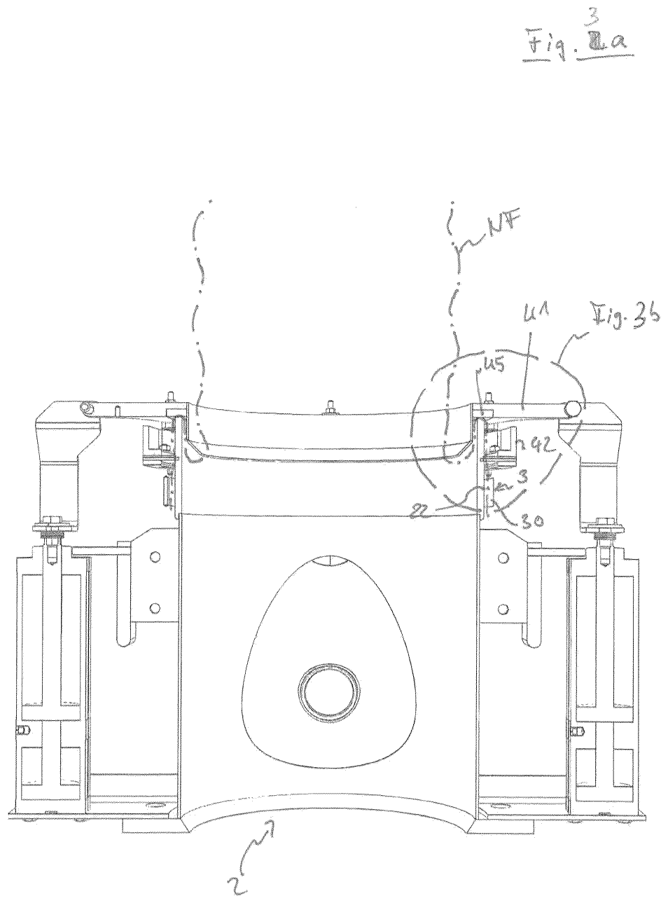

FIG. 2a shows the connecting device according to the invention, with the sealing device in an intermediate position in pressing the tubular film onto a film remnant.

FIG. 2b shows an enlarged view of the area circled in FIG. 2a.

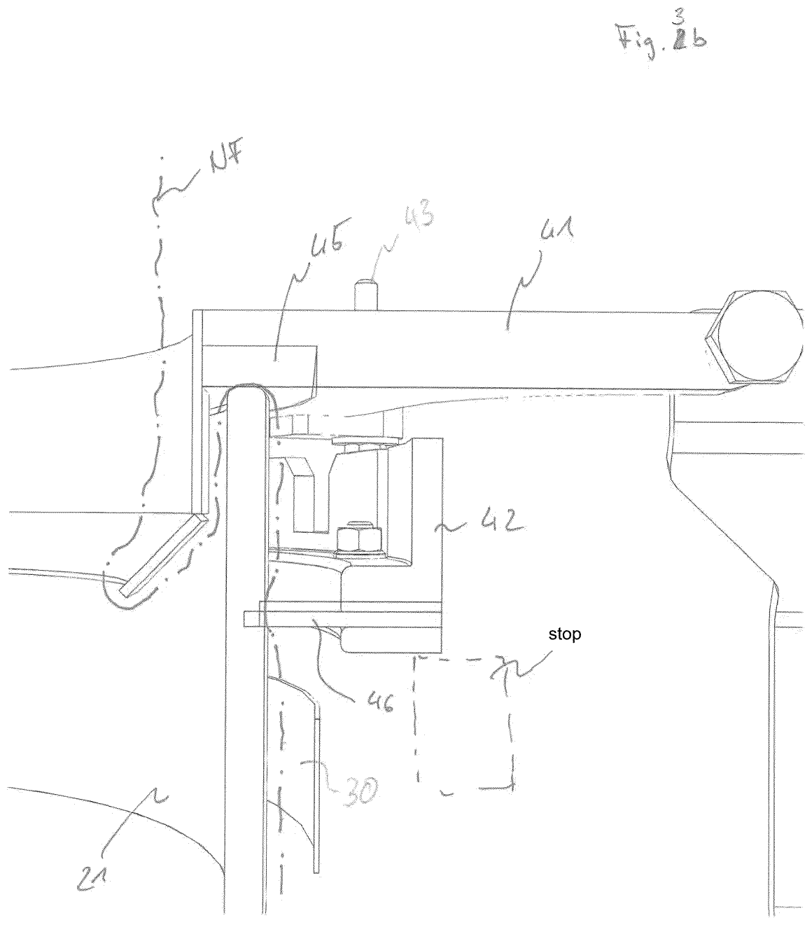

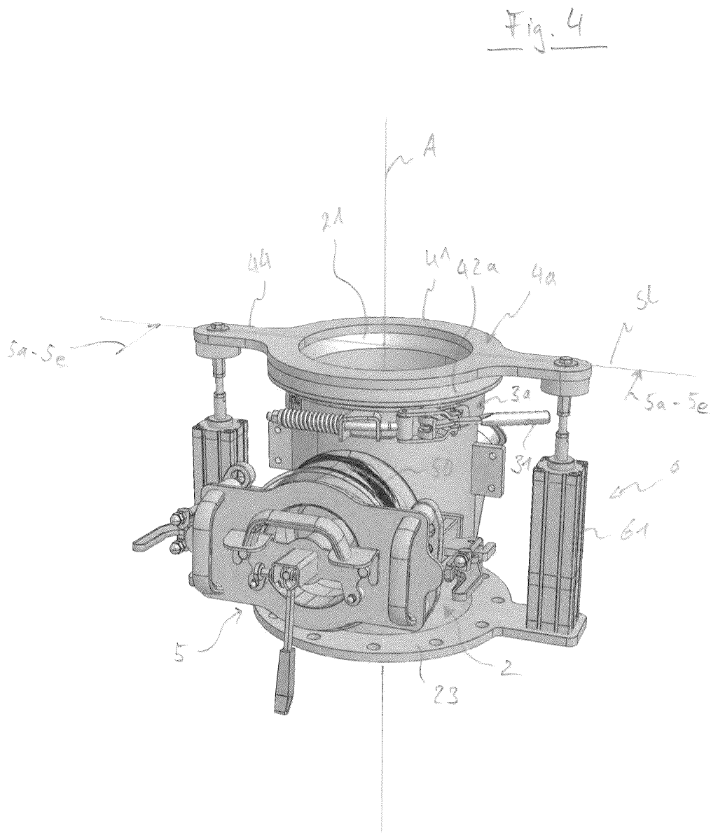

FIG. 3a shows the connecting device according to the invention, with the sealing device in a sealing position sealing the tubular film at an opening.

FIG. 3b shows an enlarged view of the area circled in FIG. 3a.

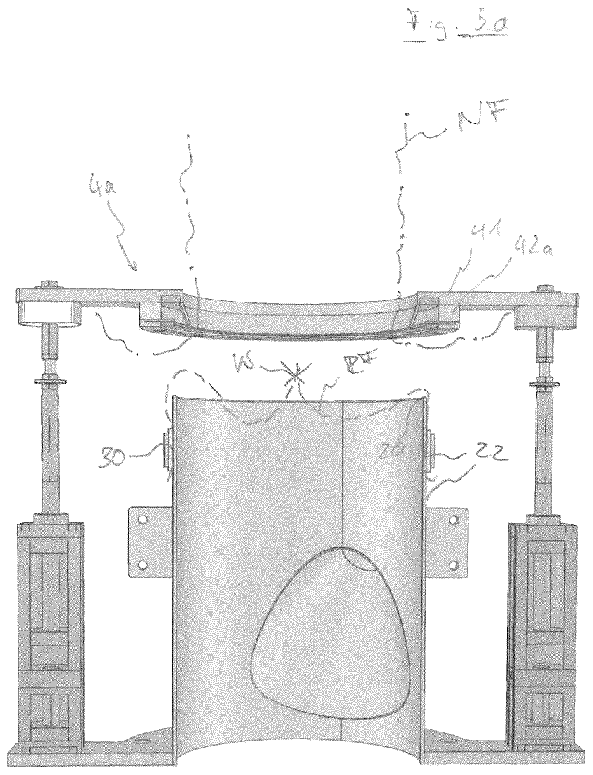

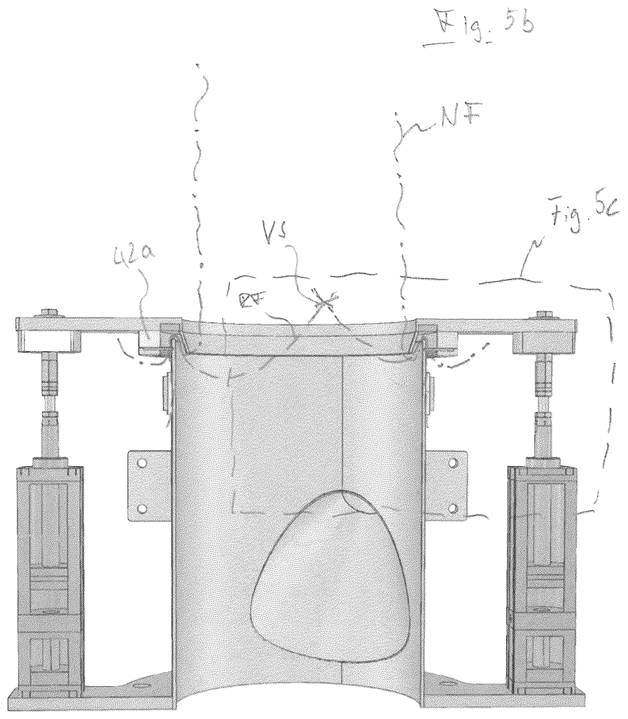

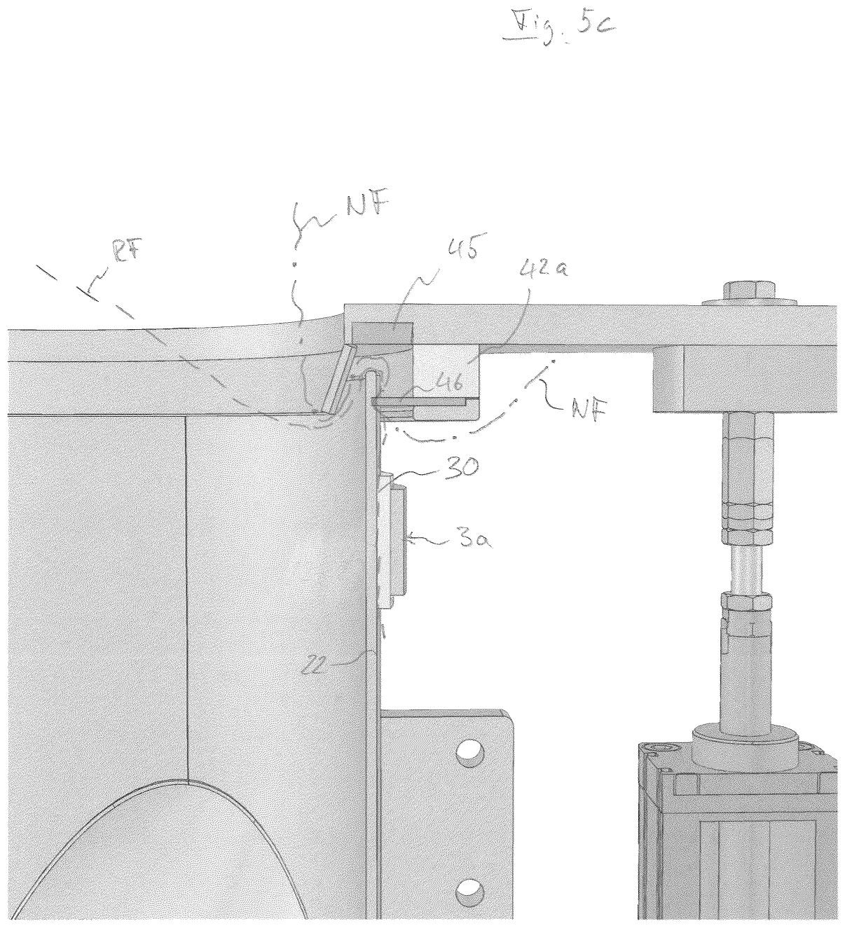

FIG. 4 shows a modified connecting device according to the invention in a perspective view, wherein the modification of the connecting device shown, compared to that in FIGS. 1a to 3b, is that the sealing device and the clamping device are designed differently.

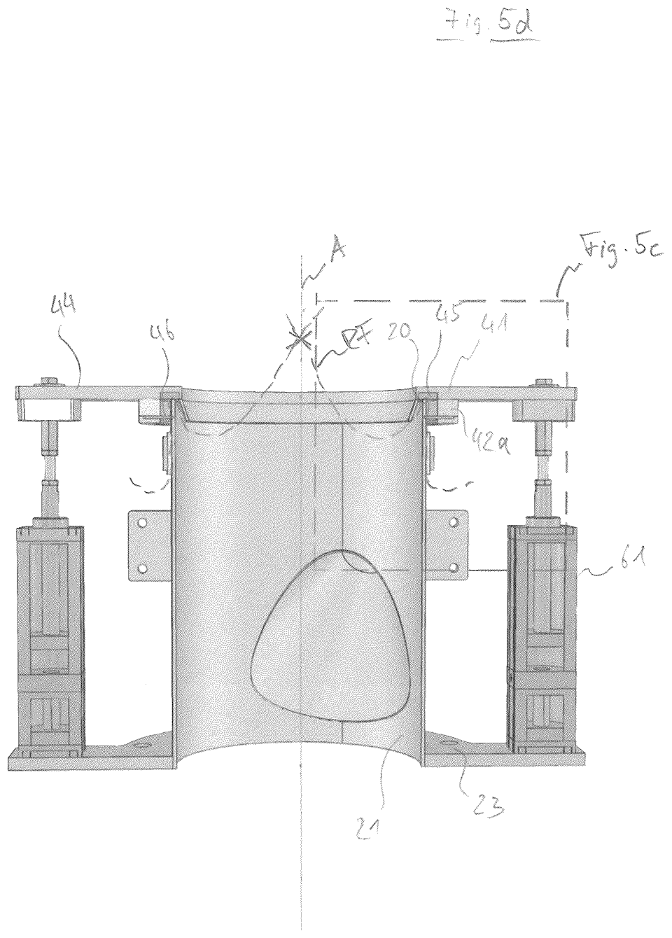

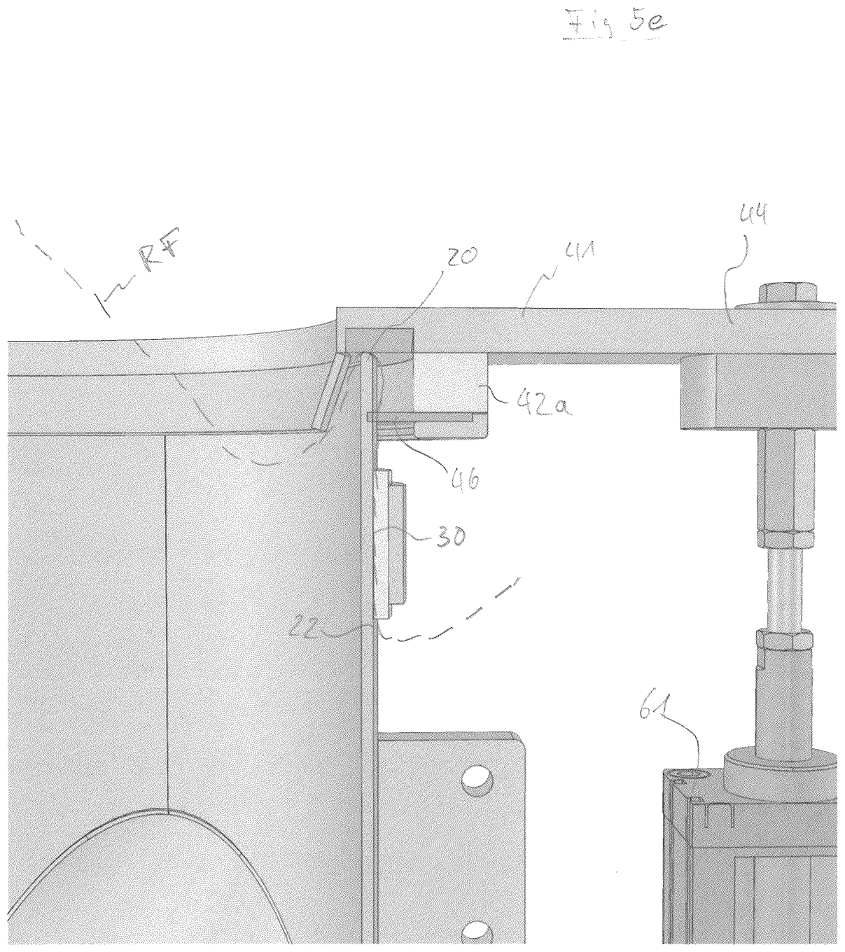

FIGS. 5a to 5e show the modified connecting device according to the invention in sectional views, wherein FIG. 5a shows the modified connecting device analogous to FIG. 1b in a connecting position, FIGS. 5b and 5c show the modified connecting device analogous to FIGS. 2a and 2b in an intermediate position, and FIGS. 5d and 5e show the modified connecting device analogous to FIGS. 3a and 3b in a sealing position.

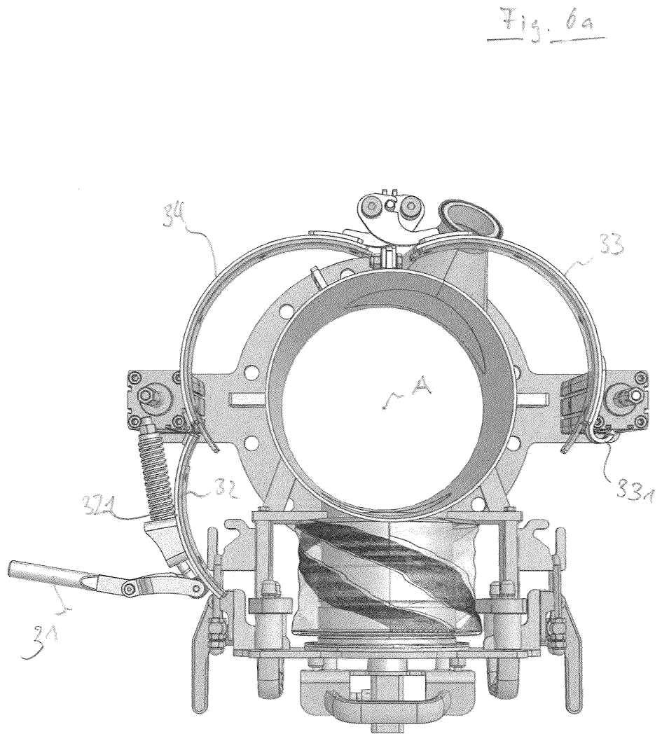

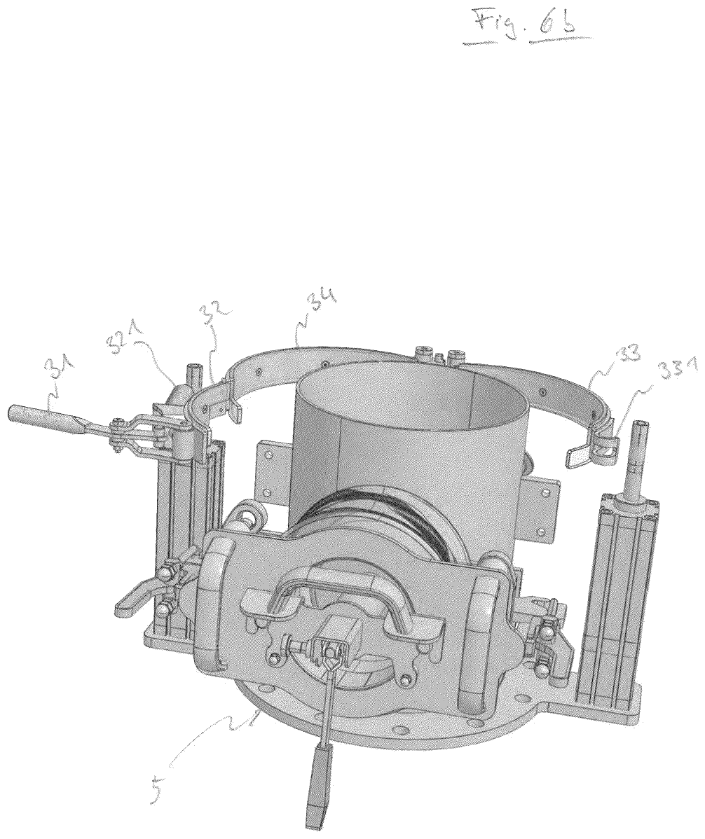

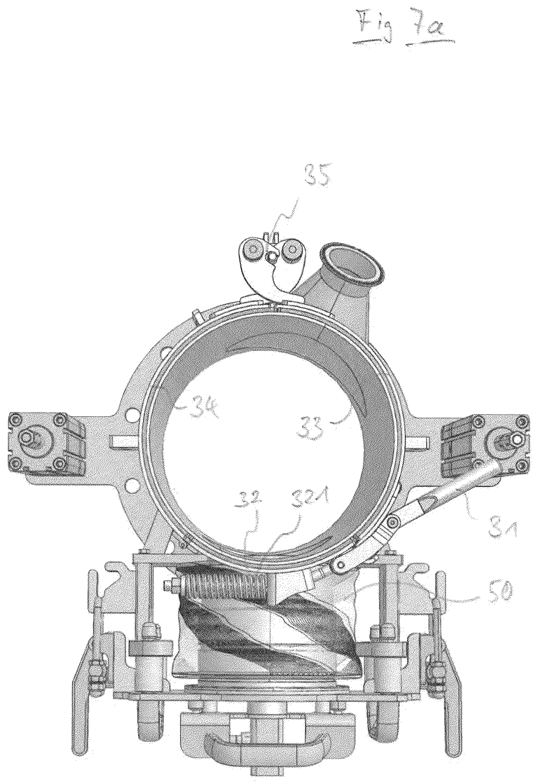

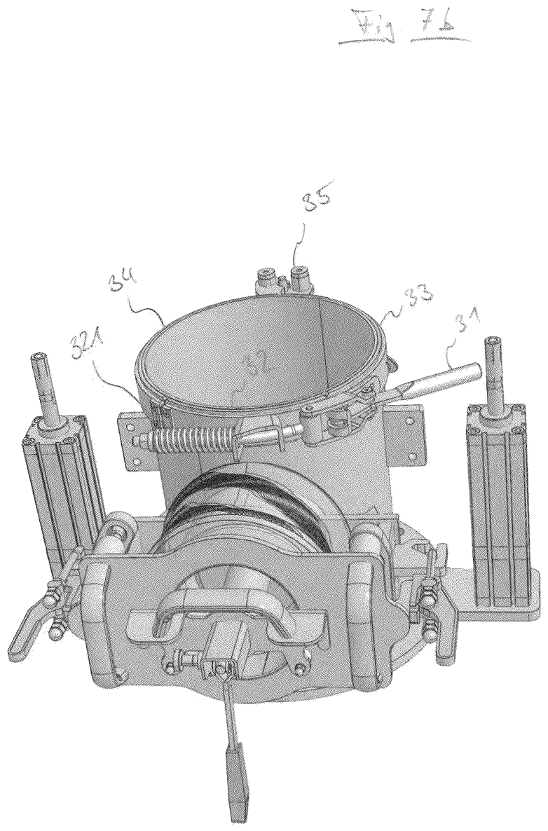

FIGS. 6a to 7b show the modified connecting device in a sectional view with a sectional plane that runs perpendicular to the sectional planes in FIGS. 5a to 5e and is located between the clamping device and the sealing device, wherein the clamping device is opened in FIG. 6a/6b and closed in FIG. 7a/7b.

FIG. 1a shows a perspective view of a connecting device 1 according to the invention. The further FIGS. 1b and 3b show the connecting device 1 in a sectional view, wherein the corresponding sectional plane is spanned by a sectional line SL shown in FIG. 1a and a channel axis A. The viewing direction corresponding to FIGS. 1b to 3b is also shown in FIG. 1a and referenced 1b-3b.

The connecting device 1 comprises a base body 2, a clamping device 3, a sealing device 4 and a lateral access 5.

The sealing device 4 is preferably adjustable via a guide/lifting device 6 and is moved as close as possible to the base body 2 in FIG. 1a. This position of the sealing device 4 corresponds to a sealing position that will be described in more detail below.

According to the invention, the connecting device 1 is used to connect a tubular film to a device, for example to connect a container to the device.

In the bulk goods manufacturing industry, for example, powdered/granular products are filled from facilities such as production plants or silos into containers such as big bags or barrels.

The filled containers are then emptied by the bulk goods processing industry into facilities such as processing plants or silos in order to subject the product to further processing or to store it for later processing.

In both processes, i.e., during filling and/or emptying, the containers are preferably connected to the corresponding device via a tubular film. The tubular film can be part of the container itself or a simple tubular connecting film that extends between the container and the device.

For example, the tubular film can be the inlet/outlet of a big bag or the inlet/outlet of an inner bag of a barrel. The connecting device 1 according to the invention allows a reliable and safe connection of such a tubular film and is in particular a connecting device for filling and/or emptying containers.

### Base Body 2

The design of the base body is explained with reference to FIGS. 1a and 1b.

The base body 2 forms a channel 21 in its interior, which extends along the aforementioned channel axis A. The base body 2 is made of metal, for example. The channel axis A corresponds to the longitudinal axis of the base body 2. The diameter of channel 21 is 0.3 m, 0.4 m, 0.5 m, for example.

When the connecting device 1 according to the invention is used as intended, the product can be transferred in the direction of the channel axis A through the base body 2 or the channel 21.

The channel 21 opens at a connecting end of the connecting device 1, to which the tubular film is to be connected as intended, via an opening 20 of the base body 2 into the external environment of the connecting device 1.

A mounting flange 23 is arranged at an opposite end of the base body 2, via which the connecting device 1 can be attached to the corresponding device, for example by means of screw connections. The base body 2 can also be designed differently for attachment to the device; for example, the base body 2 can be attached to the device using clamp connections, such as tri-clamp clamps, or using pipe couplings or sleeve connections, such as BMF connections. The channel 21 opens into the aforementioned device at the opposite end after mounting the connecting device 1.

The connecting device 1 also includes a lateral access 5, which is formed to the base body 2. The lateral access 5 is used to remove a film remnant RF from a previously connected tubular film.

So that the removal of the film remnant RF can be carried out without contamination, the lateral access 5 enables a film bag or preferably a continuous tubular film 50 to be attached. Alternatively, an elastic glove can be attached to the lateral access 5.

A user can pull off the continuous tubular film 50 in sections from the lateral access 5 and thereby access the base body 2 through the lateral access 5 to pull said film remnant RF into the channel 21 and, from there, out of the base body 2 into the pulled-off continuous tubular film after releasing the clamping device 3 explained below.

The film remnant RF in the continuous film 50 is enclosed therein by a first closure. A second closure can then be placed. To dispose of the film remnant RF, the continuous tubular film 50 is cut between the first and second closure.

The lateral access 5 can preferably be closed by a cover 51, which ensures that no product accumulates in the lateral access 5.

### Clamping Device 3

The clamping device 3 is used in particular for fastening and sealing a tubular film to be connected. The clamping device 3 is a tensioning strap shown in FIG. 1a or, as explained below, alternatively a held bag clamp, each of which can be opened and closed at a corresponding fastener.

The clamping device 3, in particular the tensioning strap shown or the bag clamp explained later, is designed in such a way that it completely encircles the base body 2 and presses the tubular film with a flat clamping surface 30 flat against an outer surface 22 of the base body 2 in a clamping region without changing the course.

The outer surface 22 of the base body 2 extends from the clamping region to the opening 20 preferably exclusively in a straight line, in particular parallel, to the channel axis A and is therefore completely flat.

### Sealing Device 4

The connecting device 1 according to the invention also includes the sealing device 4, which is described below with reference to FIGS. 2a and 2b.

The sealing device 4 comprises a sealing ring 41 and a strip ring 42.

The sealing ring 41 carries a seal 45 on the side facing the opening 20 of the base body 2, which seals the tubular film against an end face of the opening 20 when the sealing device 4 is in a sealing position that will be explained below.

The strip ring 42 is connected to the sealing ring 41 via connecting elements 43, for example. The connecting elements 43 are dimensioned in such a way that they hold the strip ring 42 at a distance from the sealing ring 41.

The strip ring 42 has a sealing lip 46 on the side facing the channel axis A. The sealing lip 46 is used to strip a new tubular film to be connected over the film remnant RF, which is clamped in place by the clamping device 3. The corresponding function is explained in detail below.

The sealing device 4 is attached to the guide device 6, which for example has two lifting cylinders 61, via guide portions 44, which are formed at a certain distance from each other in the circumferential direction of the sealing ring 41. The lifting cylinders 61 are pneumatically adjustable in the direction of the channel axis A, for example, wherein the sealing device 4 can be moved or adjusted axially to the channel axis A.

In the following, with reference to FIGS. 1b, 2a, 2b, 3a and 3b, the connection of a tubular film as intended with the connecting device 1 is described.

The process described corresponds to emptying a BigBag, although the invention is not limited to this.

In particular, the sealing device 4 can be adjusted in at least three positions.

### Connecting Position or Initial Position

In FIG. 1b, the sealing device 4 is in an initial position or connecting position, in which it is preferably moved away from the base body 2 as far as possible by the guide device 6.

In this position, the sealing device 4 is at such a distance from the base body 2 that a new tubular film NF, which is part of the BigBag for example, can be pulled over the base body 2 through the sealing ring 41 and the strip ring 42. In FIG. 1b, the new tubular film NF is folded/crimped upwards after passing through the sealing ring 41 and the strip ring 42.

A film remnant RF closes the opening 20 of the base body 2.

The film remnant RF originates from a previously connected BigBag, which was removed after transfer (e.g., emptying) of the product by tying its tubular film twice and cutting it between the corresponding closure points. The sealing point VS remaining on the film remnant RF is shown in FIG. 1b.

The film remnant RF is clamped in a sealed manner to the outer surface 22 in the clamping region by the clamping device 3, in that the clamping device 3 presses the film remnant with its flat clamping surface 30 onto the outer surface 22.

### Intermediate Position

The guide device 6 moves the sealing device 4 from the connecting position shown in FIG. 1b to the intermediate position shown in FIGS. 2a and 2b.

This adjustment is carried out by the guiding device 6 until the sealing lip 46 reaches the base body 2 and the new tubular film NF slides axially to the channel axis A over the film remnant RF. FIG. 2a shows the position reached by the sealing device. The lifting cylinders 61 are only shown in their fully retracted states for technical drawing reasons.

At the same time, the sealing lip 46 presses the new tubular film NF onto the film remnant RF, the pressure being sufficient for the sealing lip 46 to press the film remnant RF indirectly against the outer surface 22 of the base body 2 via the new tubular film NF.

In the intermediate position reached, the user can open the tensioning strap 3 by opening/releasing a buckle/clasp (not shown) and leaving it hanging in this state, extending around the base body 2.

In this intermediate position, the user can now grasp the film remnant through the access 5 and, as already explained, remove it from the opening 20. In this course the user pulls the film remnant RF away from under the new tubular film NF, with the sealing lip 46 maintaining the pressure. This process is easy for the user and does not require much force, as the remaining film runs in a straight line on the outer surface 22 and is only pressed flat by the tensioning strap 3.

The user can then close the tensioning strap 3a again and thereby press the new tubular film NF in the clamping region against the outer surface 22 of the base body 2 in a sealed manner, wherein the clamping surface 30 of the tensioning strap 3 clamps the new tubular film NF to the outer surface 22 in a sealed manner.

### Sealing Position

The guide device then moves the sealing device 4 into the sealing position shown in FIGS. 3a and 3b, wherein the seal 45 of the sealing ring 41 presses the new tubular film against the end face of the opening 20 of the base body 2 in a sealed manner.

Closing the tensioning strap 3 and the resulting clamping of the new tubular film NF can also only take place in the state that has now been reached.

In a merely preferred variant, the strip ring 42 is mounted so that it can be displaced relative to the sealing ring 41, wherein it abuts against a stop (FIG. 3b) in the intermediate position of the sealing device 4. As a result, the strip ring 42 remains stationary when the sealing device 4 is adjusted from the intermediate position to the sealing position and the tubular film is not pulled outwards until the sealing position is reached.

The BigBag can then be opened to transfer the product into the device. After emptying the BigBag, the tubular film is tied twice and cut.

The process then returns to FIG. 1b for connecting a new container.

It should be emphasized that clamping by the clamping device 3, the preferably sealed pressing by the sealing lip 46 and the sealing by the seal 45 is carried out flat without changing the course of the film. In particular, no clamping devices are provided in which the film (NF/RF) is folded or clamped.

This makes it much easier for the user to pull out the film remnant RF through the access 5, because no radial constrictions or axial folds that form resistance need to be released manually.

### Modifications

In the following, a variant of the connecting device 1a according to the invention is explained with reference to FIGS. 4 to 7b, which has been modified compared to the connecting device 1 from FIGS. 1a to 3b.

Those elements of the modified connecting device 1a that are identical to those in FIGS. 1a to 3b have identical reference symbols and are not explained again.

The procedure for emptying a BigBag is identical to that shown in FIGS. 1b to 3b, although, as already mentioned, the invention is not limited to emptying.

FIG. 4 shows the modified connecting device 1a in a perspective view, wherein the modification compared to the connecting device 1 from FIGS. 1a to 3b is that the sealing device 4a and the clamping device 3a are designed differently.

The sealing device 4a does not have any connecting elements 43, and the strip ring 42a is in contact with the sealing ring 41. A relative movement of the strip ring 42a relative to the sealing ring 41 is therefore not possible in this modified connecting device 1a. On the other hand, the sealing device 4a in the present modified connecting device 1a has a more compact design because the dimensions of the strip ring 42a in the direction of the channel axis A are smaller.

In addition, the clamping device 3a is constructed differently to the connecting device 1 in FIGS. 1a to 3b. The clamping device 3 is not a tensioning strap but is designed as the aforementioned bag clamp 3a.

The bag clamp 3a runs around the outer surface 22 of the base body 2 and can be both opened and closed using a handle 31. The handle 31, like the lateral access 5, is located on the front of the connecting device 1a, so that a user can carry out all operations from there.

FIGS. 6a, 6b, 7a, 7b show sectional views of the connecting device 1a, wherein a corresponding sectional plane runs perpendicular to the channel axis A and is arranged between the sealing device 4a and the bag clamp 3a.

The bag clamp 3a is preferably made up of three swivel arms 32, 33 and 34, which are adjustably mounted. The swivel arms 32 and 34 are connected to each other via a joint, wherein the swivel arm 32 also holds the handle 31 and the swivel arm 34 is pivotably attached to a swivel bearing 35, which carries the bag clamp 3a as a whole.

The remaining swivel arm 33 is pivotably attached to the swivel bearing 35 in the same way as the swivel arm 34.

The bag clamp 3a is held by the structure described above in such a way that the swivel arms 32, 33, 34 can be placed against the base body 2 and moved away from it.

FIGS. 6a and 6b show the bag clamp 3a in its open state.

It can be seen from this that the three swivel arms 32, 33 and 34 can be opened very wide due to their adjustable and swivel connections and that the user has sufficient space in the open state to pull the new tubular film NF over the base body 2 in the intermediate position of the sealing device 4a—after removing the film remnant RF.

The bag clamp 3a can then be closed. In a first step, the user brings the swivel arms 32, 33, 34 together and hooks a hook 331 of the swivel arm 33 into a corresponding eyelet of a tension spring 321 attached to the swivel arm 32. The bag clamp 3a does not yet develop any clamping force after hook 331 has been hooked in.

This is done in a second step, in which the user moves the handle 31 from the position shown in FIGS. 6a, 6b to the position shown in FIGS. 7a, 7b. Turning the handle 31 leads to compression of the tension spring 321, which tensions the swivel arms 32, 33, 34 in the circumferential direction around the base body 2 and thus develops the clamping force of the bag clamp 3a onto the new tubular film NF.

The procedure for emptying the BigBag is explained below with reference to FIGS. 5a to 5e.

The sequence shown in FIGS. 5a to 5e differs from that shown in FIGS. 1b to 3b only in the functionality of the bag clamp 3a and the arrangement of the strip ring 42a. In this respect, reference can also be made to the comments on FIGS. 1b to 3b in addition to the following explanations.

### Connecting Position or Initial Position

In FIG. 5a, the sealing device 4a is in the initial position or connecting position, in which it is preferably moved away from the base body 2 as far as possible by the guide device 6.

The new tubular film NF, which is part of the BigBag for example, is pulled over the base body 2 through the sealing ring 41 and the strip ring 42a. In FIG. 5a, the new tubular film NF is again folded upwards.

A film remnant RF closes the opening 20 of the base body 2.

The film remnant RF originates from a previously connected BigBag, which was removed after transfer (e.g., emptying) of the product by tying its tubular film twice and cutting it between the corresponding closure points. The sealing point VS remaining on the film remnant RF is shown in FIG. 5a.

The film remnant RF is clamped in a sealed manner to the outer surface 22 in the clamping region by the bag clamp 3a, in that the bag clamp 3a presses the film remnant with its flat clamping surface 30 onto the outer surface 22.

### Intermediate Position

The guide device 6 moves the sealing device 4 from the connecting position shown in FIG. 5a to the intermediate position shown in FIGS. 5d and 5c. This adjustment is carried out by the guide device 6 to such an extent that the strip ring 42a and the sealing lip 46 reach the base body 2. The latter sealing lip 46 strips the new tubular film NF axially to the channel axis A over the film remnant RF.

At the same time, the sealing lip 46 presses the new tubular film NF onto the film remnant RF, the pressure being sufficient for the sealing lip 46 so as to press the film remnant RF indirectly against the outer surface 22 of the base body 2 via the new tubular film NF.

In the intermediate position reached, the user can open the bag clamp 3a by moving the handle 31 from the position shown in FIG. 7a/7b and releasing the hook 331 from the eyelet. The bag clamp 3a is then in the state shown in FIG. 6a/6b.

The user then grasps the film remnant RF through the access 5 and, as already explained, removes it from the opening 20 by pulling the film remnant RF away from under the new tubular film NF, with the sealing lip 46 maintaining the pressure. Pulling this out only requires a small deal of force.

The user can then close the bag clamp 3a again and thereby press the new tubular film NF in the clamping region against the outer surface 22 of the base body 2 in a sealed manner or clamp the new tubular film NF against the outer surface 22 in a sealed manner by means of its clamping surface 30.

### Sealing Position

The user then adjusts the sealing device 4 into the sealing position shown in FIGS. 3a and 3b via the guide device 6, wherein the seal 45 of the sealing ring 41 presses the new tubular film NF against the end face of the opening 20 of the base body 2 in a sealed manner.

The closing of the bag clamp 3a and the resulting clamping of the new tubular film NF can also only be carried out in the state now reached.

The BigBag can then be opened to transfer the product into the device. After emptying the BigBag, the tubular film is tied twice and cut.

The process then returns to FIG. 5a for connecting of a new container.

For the modified connection device 1a, it should again be emphasized that the clamping by the clamping device 3 or bag clamp 3a, the preferably sealed pressing by the sealing lip 46 and the sealing by the seal 45 is carried out flat without changing the course of the film.

In particular, no clamping devices are provided in which the film (NF/RF) is folded or clamped. This makes it much easier for the user to pull out the film remnant RF through the access 5, because no radial constrictions or axial folds that form resistance need to be released manually.

What is claimed is:

1. Connecting device (1) for connecting a tubular film to a device to transfer a product, in powder/granular form, through the tubular film into and/or out of the device, the connecting device (1) comprising:
a base body (2) forming a channel (21) through which the product flows during transfer, wherein the channel (21) extends along a channel axis (A) and ends at an opening of the base body (20) and opens to the outside;
an adjustable sealing device (4) being adjustable between (i) a connecting position in which it is spaced from the base body (2) and allows the tubular film to be drawn over the base body (2), and (ii) a sealing position in which it seals the tubular film drawn over the base body (2) with respect to the base body (2) for transferring the product; and
a clamping device (3) which runs around the base body (2) and is configured to clamp the tubular film drawn over the base body (2) in a sealed manner in a clamping region by pressing the tubular film flat against the base body (2) in the clamping region without changing its course; wherein
the adjustable sealing device (4) can be moved into an intermediate position located between the connecting position and the sealing position, in which it presses the tubular film drawn over the base body (2) without changing its course onto a film remnant clamped in the clamping device (3), which originates from a previous transfer, in such a way that the film remnant rests against the base body and can be pulled manually into the channel (21) after the clamping device (3) has been released.

2. The connecting device according to claim 1, wherein
the tubular film is fixed exclusively by the sealing device (4) when the sealing device is in the intermediate position and presses the tubular film onto the film remnant, and
the tubular film is clamped in the clamping region by the clamping device as intended after the film remnant has been pulled into the channel (21).

3. The connecting device according to claim 1, wherein
in the intermediate position, the sealing device (4) presses the tubular film radially and/or axially to the channel axis (A) onto the film remnant.

4. The connecting device according to claim 1, wherein
the sealing device (4) comprises (i) a sealing ring which, in the sealing position of the sealing device (4), seals the tubular film radially and/or axially relative to the channel axis (A) with respect to the base body (2), and (ii) a strip ring held at a distance from the sealing ring, which strips the tubular film over the film remnant and presses it onto the film remnant when the sealing device is adjusted so as to be in the intermediate position.

5. The connecting device according to claim 4, wherein
when the sealing device is adjusted to be in the intermediate position, the strip ring strips the tubular film axially to the channel axis over the film remnant and presses radially to the channel axis onto the film remnant, and
the sealing ring seals the tubular film by adjusting the sealing device from the intermediate position to the sealing position axially to the channel axis (A) opposite an end face of the opening.

6. The connecting device according to claim 4, wherein
the strip ring can be moved axially to the channel axis relative to the sealing ring and remains stationary when the sealing device is adjusted from the intermediate position to the sealing position.

7. The connecting device according to claim 1, wherein
the base body has an outer surface running exclusively parallel to the channel axis, at least from the clamping area to the opening, onto which the sealing device presses the film residue in the intermediate position indirectly over the tubular film and onto which the clamping device presses the tubular film in the clamping area without changing the course.

8. The connecting device according to claim 1, wherein
the clamping device is a tensioning strap or a bag clamp that presses the tubular film flat against the base body.
